(19) United States
(12) Patent Application Publication
(10) Pub. No.: US 2017/0074451 A1
(43) Pub. Date: Mar. 16, 2017

(54) FOOT AND LEG EXCHANGE ASSEMBLY FOR A DEVICE SUPPORT APPARATUS

(71) Applicant: Clinton Sharp, Spokane, WA (US)

(72) Inventor: Clinton Sharp, Spokane, WA (US)

(21) Appl. No.: 15/261,646

(22) Filed: Sep. 9, 2016

Related U.S. Application Data
(63) Continuation of application No. 62/217,553, filed on Sep. 11, 2015.

(51) Int. Cl. F16M 11/16; F16B 7/04; F16M 11/22

(52) U.S. Cl. CPC F16M 11/16; F16M 11/22; F16B 7/042; F16M 2200/08

(57) ABSTRACT

A support attachment system includes a coupler. The coupler includes a quick-release mechanism and an apparatus connection portion coupled to the quick-release mechanism and configured to engage a leg of a device support apparatus. The system further includes an attachment adapter. The attachment adapter includes a coupler attachment portion configured to engage the quick-release mechanism, and an attachment retention portion configured to secure a support accessory structured for direct attachment to the leg of the device support apparatus.

### CROSS REFERENCE TO RELATED PATENT APPLICATIONS

This application claims priority to U.S. Provisional Patent Application No. 62/217,553, filed on Sep. 11, 2015, entitled “Bipod Foot Apparatus,” and incorporates the same in its entirety by reference.

### BACKGROUND

Several industries have a need for an apparatus to stably support a device in use so as to minimize movement of the device caused by external forces such as human interaction and environmental conditions (e.g., wind and other weather). For example, in the photography industry, cameras are often attached to monopods and tripods to provide stability in a shot and minimize blur; surveyors frequently use tripods to accurately assess and report a variety of measurements for many different projects; various industries use tripods to secure lighting equipment; and the firearm industry has a large market for the use of a device support apparatus, such as monopods, bipods, and tripods.

Among the variety of industries that use device support apparatuses, the surfaces on which these apparatuses may be placed during use vary widely. Such variance is due to the different environments, even within individual industries, in which they are used. Thus, one may understand that a single type of foot or size of leg for the device support apparatuses may not be equally supportive for every different surface on which a particular device support apparatus may be used. Furthermore, manufacturers recognize this challenge and some manufacturers produce different types of support feet that may be exchanged when desired.

Regardless, the process to exchange the feet on many device support apparatuses may be difficult and/or time-consuming and may further be limited to only unsatisfactory alternatives available for selection depending on the maker of the apparatus. For example, Brand A may make a support apparatus with features on the device connection portion of the support apparatus that are more desirable to a user than the features of the device connection portion of a different support apparatus made by Brand B. However, in the same example, the user may prefer the feet (and/or leg) features of Brand B over those of Brand A. In such an example situation, quite frequently, it occurs that the feet/leg features of Brand A and Brand B cannot be interchangeable due to different connection means. Thus, the user is left to choose whether to purchase both apparatuses and have swap the entire apparatus depending on the particular instant need/desire, or to choose to purchase just one of the apparatuses and determine which aspect provides greater overall satisfaction.

In a different example situation, a user may prefer all aspects of the apparatus of Brand A generally. Yet, to exchange a foot/leg for different situations and surfaces may be so challenging and/or time-consuming that the user may not end up swapping the foot/leg on the device support due to lack of motivation or time, and instead, the user may end up sacrificing quality of use despite the technical capability of swapping.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates a perspective view of an application to a bipod of a support attachment system according to an embodiment of the instant application.

FIG. 2A illustrates an exploded side view of a support attachment system according to an embodiment of the instant application.

FIG. 2B illustrates an exploded side view of another support attachment system according to an embodiment of the instant application

FIG. 3A illustrates a top perspective view of a coupler according to an embodiment of the instant application.

FIG. 3B illustrates a bottom perspective view of the coupler in FIG. 3A according to an embodiment of the instant application.

FIG. 3C illustrates a perspective view of another coupler according to an embodiment of the instant application.

FIG. 4A illustrates a top perspective view of an adapter according to an embodiment of the instant application.

FIG. 4B illustrates a bottom perspective view of the adapter in FIG. 4A according to an embodiment of the instant application.

FIG. 4C illustrates a perspective view of another adapter according to an embodiment of the instant application.

FIG. 5 illustrates a variety of support attachments according to an embodiment of the instant application.

### DETAILED DESCRIPTION

### Overview

For the purposes of illustrative practicality, and due to the simple applicability of the invention to the firearm industry, the further description and explanation of features is primarily directed and depicted to device support apparatuses used in the firearm industry. Nevertheless, the principle features discussed herein may be applied to other device support apparatuses in other industries, and these features may be claimed as such to apply to other device support apparatuses consistent with the invention.

In the firearm industry, when shooting a firearm, it may be desirable to have a stable support upon which to rest the firearm, so as to improve the accuracy of shot placement. In general, when a person shoots a handheld firearm in any number of positions, including prone, sitting, or standing, the natural rhythmic and irregular motions of various parts of the human body caused by many factors including breathing, vascular flow, muscle fatigue, etc., may interfere with a person's ability to accurately shoot the desired location on a target of interest.

In order to counter or minimize the potential interference of minute shifts in the aim of a firearm, a person shooting the firearm may attempt to use a physical object or device as a stabilizing support. Various types of devices, such as monopods, bipods, and tripods are used to support firearms, as indicated above, and thereby minimize unintentional movement by the shooter's body. However, frequently, a shooter may need to switch positions for different shots at different targets and/or in different environments, terrains, or shooting arrangements. Accordingly, as briefly discussed above, the use of a single device, whether it be a monopod, bipod, or tripod may not always be satisfactory due to the differences in the interaction and engagement between the style, material, size, and/or configuration of the foot or feet of the device and the surface upon which the device is set. Furthermore, even different firearms due to variations in weight or configuration may cause the support apparatus to react differently. For example, in some instances, spiked feet may slide on a rigid and/or slick surface, such as a table or a rock, while being completely suitable for a softer or more elastic surface, such as on the dirt or a wooden tabletop.

Furthermore, there are various brands and manufacturers of support devices, each of which may serve a certain purpose or portion of the market and consumers for different reasons. As such, a consumer may own more than one support device for different uses. However, it may be inconvenient to carry more than one support device due to excess size and/or weight of the multiple support devices. Therefore, it may be desirable to have a system for quickly and easily interchanging different foot and/or leg attachments to a single device support apparatus regardless of the make or model of the apparatus.

The instant application describes a system of components for assembly that interact together to permit rapid exchange of footing configurations for a device support apparatus, such as a bipod for a firearm, according to a user's desire, which may vary depending on the surface on which the user is using the device being supported. The assembly may include a coupler and at least one of an adapter or a compatible foot attachment. Additionally, and/or alternatively, a leg extension may be implemented. The coupler may be configured to connect fixedly or removably to a particular brand's support apparatus in a manner consistent with the functional attachment means of the particular support apparatus For example, the coupler may be connected to the support apparatus in place of the original feet.

Using the coupler, a device support apparatus may be modified quickly to adapt the feet and/or legs to varying environments or surfaces on which the support device is in use and minimize the need to carry multiple support devices. As indicated above, the coupler may be placed in the location of existing OEM brand feet for support devices, such as bipods. The OEM feet and leg extensions are structured to attach directly to the device support apparatus for which the feet and leg extensions were originally manufactured. The coupler may be configured with a first end having a connection portion to connect to the support apparatus and a second end having an attachment receiving portion to receive and attach either custom or OEM feet (or legs). Feet and leg extension components may be connected to the attachment receiving portion of the coupler via an adapter that is configured to directly connect to the coupler on one side and to accommodate the connection means of the feet and leg extension components on the other side.

In some instances, the attachment receiving portion of the coupler may be a quick-release mechanism, such as a ball-bearing sleeve lock. The ball-bearing sleeve lock may have an outer sleeve that maintains a biased pressure against a series of ball bearings internal to the outer sleeve to force the ball bearings in a secure position. A quick-release mechanism permits the connection and disconnection of attachments, such as the adapter or custom accessories, in a simple and rapid manner that may be achieved, for example, single-handedly and/or with minimal action or effort by the user. For example, with a ball-bearing sleeve lock, the quick and simple single action of sliding the outer sleeve either up or down. Other quick disconnect mechanisms are contemplated, including, but not limited to a single-lever post clamp, a twist lock, a threaded connection, etc.

Adapters and extensions may be interchangeable from quick disconnect couplers designed for specific brands or support device models. The components of the couplers, adapters, feet, leg extensions, and assembly pieces may be constructed of materials such as steel, aluminum, stainless steel, other suitable metals, etc. Further, the components may be made of a rigid polymer or other durable material suitable for manufacturing according to desired tolerances and longevity/durability specifications.

### ILLUSTRATIVE EMBODIMENTS

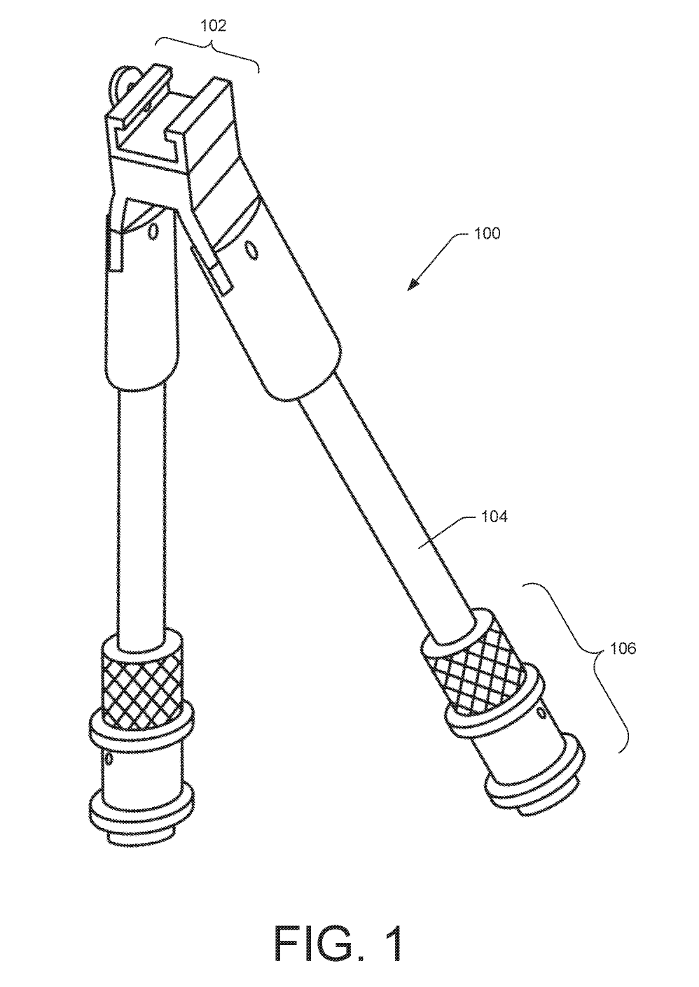

Specifically, FIG. 1 depicts a bipod as an example of a device support apparatus 100 with which the quickly interchangeable components, as discussed herein, may be used. Device support apparatus 100 may include a device support attachment portion 102. The attachment portion 102 may be of any format or structure that permits attachment of a desired device. In this example, the attachment portion 102 is depicted as a bracket or brace structure with a set screw mechanism. Attachment portion 102, as depicted in FIG. 1, may correspond to attaching a rail used on a firearm or a bracket for a camera, etc.

Generally, a support apparatus, may further include one or more legs 104, which in the case of a bipod, such as apparatus 100, is two. A proximal end of leg 104 connects to attachment portion 102, and the distal end of leg 104 extends toward a surface on which apparatus 100 may support a device. The distal end of leg 104 may attach to a support attachment system 106 according to the instant application for quickly swapping out feet or extensions, etc., depending on the different purposes/uses. As indicated above, the support attachment system 106 may be used for any device support apparatus, for example, supporting cameras, survey equipment, lights, firearms, etc.

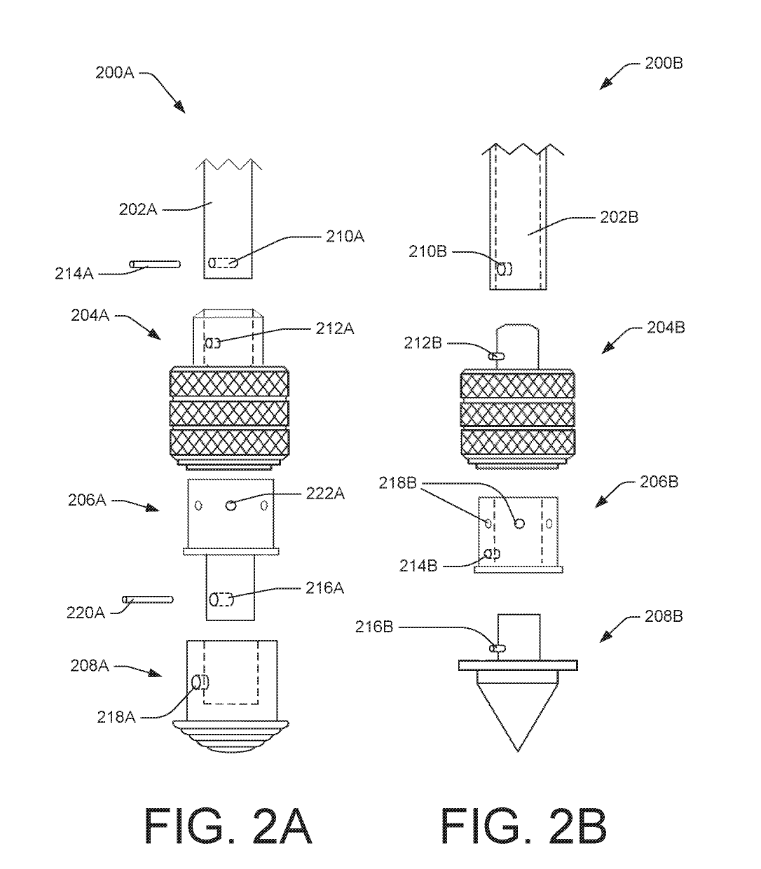

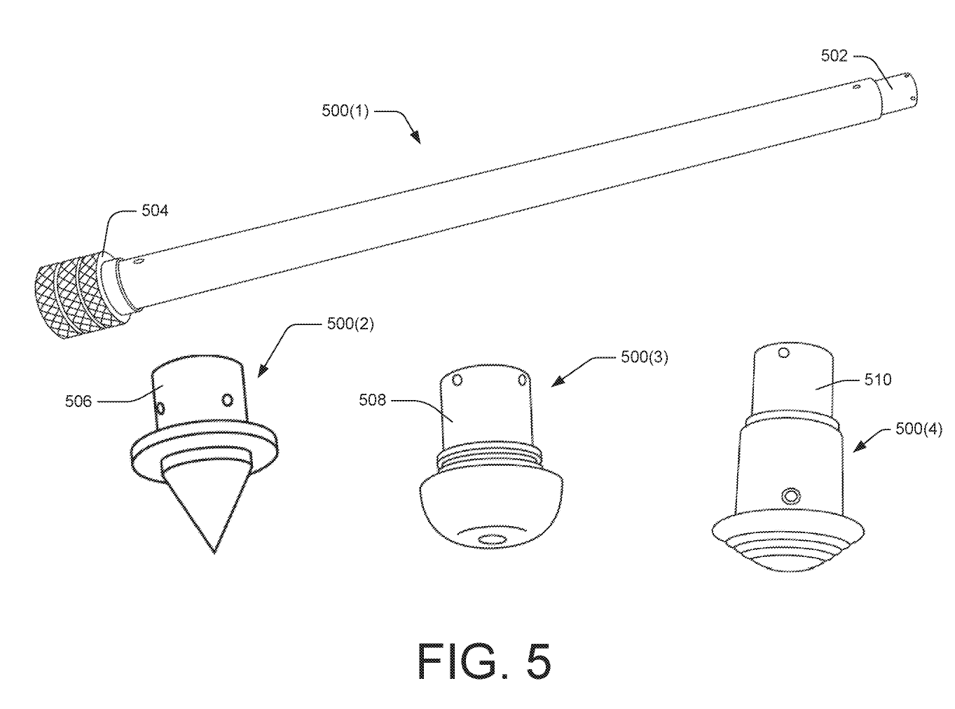

FIGS. 2A and 2B depict alternative embodiments of a support attachment system 200A and 200B, respectively. In the exploded view shown in FIG. 2A, support attachment system 200A is configured to attach to a leg 202A of a device support apparatus (only a portion of leg 202A is shown). A coupler 204A may be connected directly to leg 202A in a manner consistent with the original device support apparatus, discussed in greater detail herein below. In some instances, to implement quick attachment and release capabilities of a support attachment that is not directly compatible with the coupler 204A, adapter 206A may be connected to coupler 204A. Adapter 206A may further be configured to connect and retain a support attachment 208A. Note that adapter 206A may accept a variety of support attachments, such as those seen in FIG. 5, and not only support attachment 208A as depicted.

Moreover, in some instances, coupler 204A may attach directly to leg 202A by inserting leg 202A into a opening in coupler 204A and aligning a hole 210A in leg 202A with a hole 212A, and then inserting a pin 214A into the aligned holes 210A, 212A. Similarly, a support attachment 208A, such as afoot or a leg extension, may be attached directly to adapter 206A by inserting a retention portion of adapter 206A into an opening in support attachment 208A and aligning a hole 216A in adapter 206A with a hole 218A in support attachment 208A, and then inserting a pin 220A into the aligned holes 216A, 218A.

Adapter 206A may be releasably attached in a quick manner to coupler 204A by inserting a portion of adapter 206A into coupler 204A. In some instances, adapter 206A may include one or more detents 222A that are sized to engage with a ball-bearing sleeve lock quick-release mechanism in coupler 204A. Thus, while the alignment of holes between a leg of a device support apparatus and a support attachment and the insertion of a pin into the holes is one manner of attaching a support attachment, it is tedious, somewhat challenging, and time-consuming, particularly when needing to change to a different support attachment frequently and/or quickly. Whereas, by connecting an adapter to each support attachment that one might use, the process of attachment to the device support apparatus using a coupler with a quick-release mechanism is significantly easier and faster than the aforestated method of attachment and release.

Additionally, and/or alternatively, in the exploded view shown in FIG. 2B, support attachment system 200B is configured to attach to a leg 202B of a device support apparatus (only a portion of leg 202B is shown). A coupler 204B may be connected directly to leg 202B in a manner consistent with the original device support apparatus, discussed in greater detail herein below. In some instances, to implement quick attachment and release capabilities of a support attachment that is not directly compatible with the coupler 204B, adapter 206B may be connected to coupler 204B. Adapter 206B may further be configured to connect and retain a support attachment 208B. Note that adapter 206B may accept a variety of support attachments, such as those seen in FIG. 5, and not only support attachment 208B as depicted.

Moreover, in some instances, coupler 204B may attach directly to leg 202B by inserting a portion of coupler 204B into an opening in leg 202B and aligning a detent pin slot 210B in leg 202B with a spring assisted detent pin 212B, which can be compressed for insertion into the opening in leg 202B. Similarly, a support attachment 208B, such as a foot or a leg extension, may be attached directly to adapter 206B by inserting a portion of support attachment 208A into an opening of a retention portion of adapter 206A and aligning a detent pin slot 214B in adapter 206B with a spring assisted detent pin 216B in support attachment 208B, which can be compressed for insertion into the opening in adapter 206B.

Adapter 206B may be releasably attached in a quick manner to coupler 204B by inserting a portion of adapter 206B into coupler 204B. In some instances, adapter 206B may include one or more detents 218B that are sized to engage with a ball-bearing sleeve lock quick-release mechanism in coupler 204B. Thus, while the alignment of a detent pin slot in a leg of a device support apparatus with a spring assisted detent pin in a support attachment to another manner of attaching a support attachment, it is tedious, somewhat challenging, and time-consuming, particularly when needing to change to a different support attachment frequently and/or quickly. Whereas, by connecting an adapter to each support attachment that one might use, the process of attachment to the device support apparatus using a coupler with a quick-release mechanism is significantly easier and faster than the aforestated method of attachment and release.

In some instances, as discussed above, the quick-release mechanism of the coupler may be a ball-bearing sleeve lock mechanism. However, it is contemplated that other quick-release mechanisms are suitable provided there is a locked state and a release state.

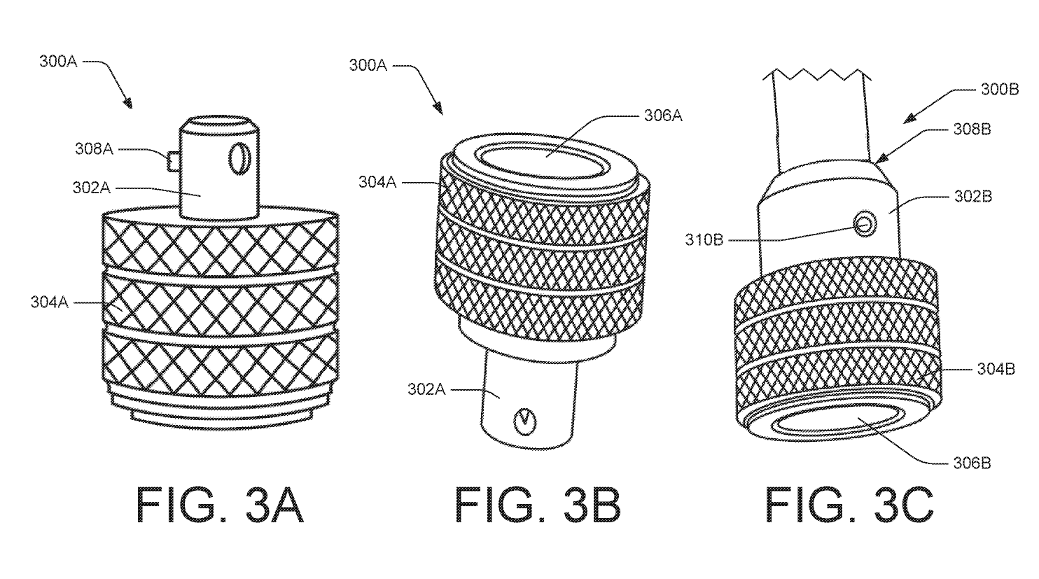

FIGS. 3A and 38 depict the same coupler 300A from different perspectives, namely, top and bottom perspectives, respectively. Coupler 300A may include an apparatus connection portion 302A with which to connect to a device support apparatus. Further, coupler 300A may include a quick-release coupling mechanism 304A, such as a ball-bearing sleeve lock (ball-bearings not shown) having an opening 306A into which an adapter may be inserted for retention. Apparatus connection portion 302A may include a shaft extending from the quick-release coupling mechanism 304A. In some instances, such as depicted in FIGS. 3A and 3B, the shaft may be substantially solid and cylindrical, and may be sized to correspond to a structure that connects directly with a leg of a device support apparatus, via insertion of the shaft into the leg. As depicted, the shaft of the apparatus connection portion 302A may implement a spring assisted detent pin with which to connect to the leg of a device support apparatus.

Additionally, and/or alternatively, the shaft may be hollow, as depicted in the coupler 300B in FIG. 3C, in apparatus connection portion 302B. Like coupler 300A, coupler 300B may include a quick-release coupling mechanism 304B, such as a ball-bearing sleeve lock (ball-bearings not shown) having an opening 306B into which an adapter may be inserted for retention. As indicated above, apparatus connection portion 302B may include a hollow shaft extending from the quick-release coupling mechanism 304B and having an opening 308B into which a leg of a device support apparatus may directly connect, via insertion of the leg into the shaft. Further, a pin 310B may be inserted into aligned holes between the apparatus connection portion 302B and the leg of a device support apparatus to maintain a secure connection between the coupler and the device support apparatus.

Thus, apparatus connection portions (such as 302A, 302B) of couplers may be configured to attach directly to legs of device support apparatuses in different manners according to the original structure with which a support accessory, such as a foot or leg extension, of the particular device support apparatus is structured for direct attachment to the device support apparatus.

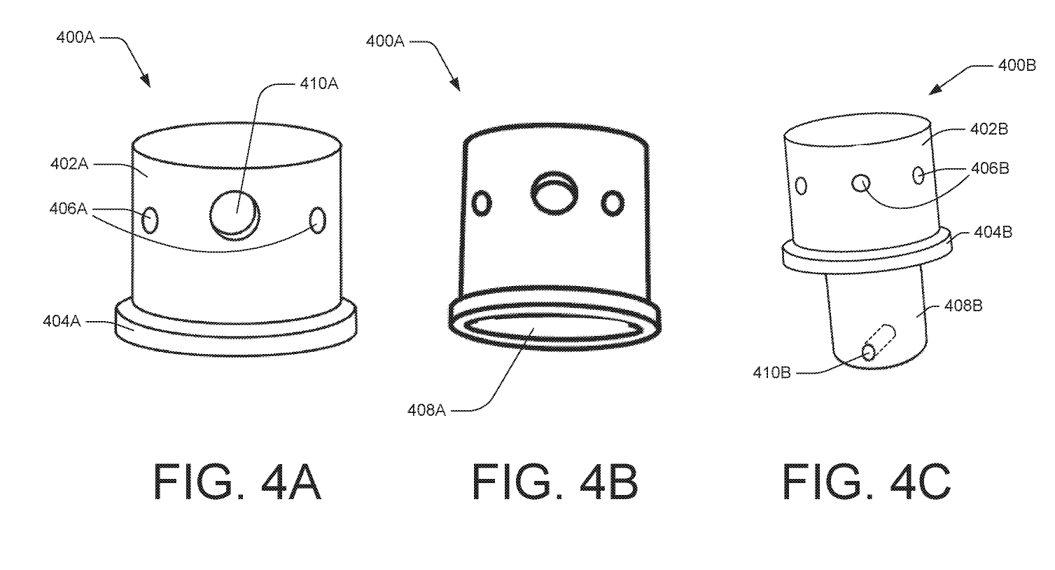

Depicted in FIGS. 4A and 4B is an adapter 400A that includes a coupler attachment portion 402A. In some instances, a flange 404A may surround a base of coupler attachment portion 402A, as depicted. However, adapter 400A may be utilized without a flange. Adapter 400A may also include one or more detents 406A (divots, slots, grooves, etc.) that engage with the quick-release mechanism of a corresponding coupler. In some instances, for example when a ball-bearing sleeve lock mechanism is implemented in the corresponding coupler, detent 406A may be a concave rounded detent into which a ball bearing presses under a bias from the outer sleeve to secure the adapter 400A.

Adapter 400A may further include a retention portion 408A having an opening into which a support accessory, such as a foot or leg extension, etc., may be inserted for attachment. In addition to the retention portion 408A, adapter 400A may include a detent pin slot 410A, which accepts a spring assisted detent pin from a corresponding support accessory, such as is depicted in FIG. 2B.

Additionally, and/or alternatively, FIG. 4C depicts adapter 400B that includes coupler attachment portion 402B. Similarly to adapter 400A, in some instances, a flange 404B may surround a base of coupler attachment portion 402B, and adapter 400B may include one or more detents 406B (divots, slots, grooves, etc.) that engage with the quick-release mechanism of a corresponding coupler. The engagement of adapter 400B with a corresponding coupler may be similar to the engagement described with respect to adapter 400A, and is not further described herein.

Adapter 400B may include a retention portion 408B including a shaft extending from a base of coupler attachment portion 402B adjacent flange 404B. Furthermore, the retention portion 408B may have a hole 410B, which, when coupled with a corresponding support accessory, is configured to receive a pin to securely retain the support accessory, such as is depicted in FIG. 2A.

In FIG. 5, a variety of support accessories are depicted. As depicted, support accessory 500(1) is a leg extension member. A first end 502 of leg extension member may be configured to attach directly to a leg of a device support apparatus. Additionally, and/or alternatively, the first end 502 may be configured to attach directly to a coupler for additional extension length. A second end 504 of leg extension member may include a coupler (or may be configured to receive a coupler).

Support accessories 500(2), 500(3), and 500(4) are various foot supports. For example, support accessory 500(2) is a spiked foot support having a custom attachment end that is configured to connect directly to the coupler without an adapter. In another example, support accessory 500(3) is a rounded rubber foot support and is depicted as attached to adapter 508 to connect to a coupler. Support accessory 500(4) is another variation of a rubber foot support and is depicted as attached to adapter 510 to connect to a coupler.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A support attachment system, comprising:
a coupler including:
a quick-release mechanism, and
an apparatus connection portion coupled to the quick-release mechanism and configured to engage a leg of a device support apparatus; and
an attachment adapter including:
a coupler attachment portion configured to engage the quick-release mechanism, and
an attachment retention portion configured to secure a support accessory structured for direct attachment to the leg of the device support apparatus.

2. The support attachment system of claim 1, further comprising a custom support accessory configured to connect directly to the coupler via the quick-release mechanism. The support attachment system of claim 2, wherein the custom support accessory is one of a foot or a leg extension member.

4. The support attachment system of claim 1, wherein the support accessory structured for direct attachment to the leg of the device support apparatus is one of a foot or a leg extension member.

5. The support attachment system of claim 1, wherein the quick-release mechanism is a ball-bearing sleeve lock mechanism.

6. The support attachment system of claim 1, wherein the apparatus connection portion of the coupler extends longitudinally along a central axis of the coupler and away from the quick-release mechanism.

7. The support attachment system of claim 6, wherein the apparatus connection portion of the coupler includes a shaft that is sized to be accommodated in a receptacle in the leg of the device support apparatus.

8. The support attachment system of claim 7, wherein the apparatus connection portion of the coupler is configured to securely attach to the leg of the device support apparatus via one of
a spring assisted detent pin that engages with a detent pin slot, or
a pin that engages in a hole passing through a wall of the leg of the device support apparatus and the shaft.

9. The support attachment system of claim 6, wherein the apparatus connection portion of the coupler includes a receptacle sized to securely receive the leg of the device support apparatus therein.

10. The support attachment system of claim 1, wherein the quick-release mechanism of the coupler includes a cavity having a shape and internal dimensions that correspond to a shape and external dimensions, respectively, of the coupler attachment portion of the attachment adapter.

11. A system for connecting a support accessory to a device support apparatus, comprising:
a coupler including a shaft configured to attach to the device support apparatus; and
a support adapter having a first connection portion to secure a support accessory structured for direct attachment to the device support apparatus and having a second connection portion to attach to the coupler,
wherein the coupler further includes a quick-release coupling mechanism configured to releasably secure the support adapter.

12. The system of claim 11, wherein the support adapter includes a flange surrounding a lateral side thereof.

13. The system of claim 12, wherein the first connection portion of the support adapter includes a receptacle sized to receive a connection end of the support accessory, an opening of the receptacle being surrounded by the flange, and the receptacle having a detent pin slot to engage with a spring assisted detent pin disposed on the support accessory.

14. The system of claim 12, wherein the first connection portion of the support adapter includes a shaft sized to be accommodated within a receptacle of the support accessory, the flange extending around a circumference of the shaft, and the shaft and the receptacle each including a hole into which a pin is engageable to secure the support accessory to the shaft.

15. The system of claim 11, wherein a largest external dimension of the second connection part of the support adapter corresponds to an internal dimension of the quick-release mechanism of the coupler.

16. The system of claim 11, wherein a sidewall of the second connection part of the support adapter includes one or more detents to engage with the quick-release coupling mechanism of the coupler.

17. The system of claim 11, wherein the shaft of the coupler connects to the device support apparatus via one of insertion of the shaft into a receptacle of a leg of the device support apparatus or insertion of the leg of the device support apparatus into a receptacle in the shaft.

18. An attachment system for interchanging support components on a leg of a device support apparatus, the attachment system comprising:
an adapter member configured to receive a support accessory structured for direct attachment to the leg of the device support apparatus, and
a quick-release coupling mechanism having an upper end configured to connect directly to the device support apparatus and having a lower end configured to connect to the adapter member and a custom support member.

19. The attachment system according to claim 18, wherein the quick-release coupling mechanism connects to the adapter member and the custom support member via a ball-bearing sleeve lock mechanism.

20. The attachment system according to claim 18, further comprising at least one custom support member, the at least one custom support member including at least one of a foot or a leg extension member.
